(19) United States
(12) Patent Application Publication
(10) Pub. No.: US 2005/0105794 A1
(43) Pub. Date: May 19, 2005

(54) Greedy support vector machine classification for feature selection applied to the nodule detection problem

(76) Inventor: Glenn Fung, Bryn Mawr, PA (US)

Correspondence Address: Siemens Corporation;Intellectual Property Department, 170 Wood Avenue South, Iselin, NJ, 08830, US

(21) Appl. No.: 10/924,136

(22) Filed: Aug. 23, 2004

Related U.S. Application Data
(60) Provisional application No. 60/497,828, filed on Aug. 25, 2003.

(51) Int. Cl. G06K 9/62; G06K 9/00

(52) U.S. Cl. 382/159; 382/131

(57) ABSTRACT

An incremental greedy method to feature selection is described. This method results in a final classifier that performs optimally and depends on only a few features. Generally, a small number of features is desired because it is often the case that the complexity of a classification method depends on the number of features. It is very well known that a large number of features may lead to overfitting on the training set, which then leads to a poor generalization performance in new and unseen data. The incremental greedy method is based on feature selection of a limited subset of features from the feature space. By providing low feature dependency, the incremental greedy method 100 requires fewer computations as compared to a feature extraction approach, such as principal component analysis.

### CROSS-REFERENCE TO RELATED APPLICATIONS

This application claims priority to U.S. Provisional Application No. 60/497,828, which was filed on Aug. 25, 2003, and which is fully incorporated herein by reference.

### BACKGROUND OF THE INVENTION

1. Field of the Invention

The present invention relates to the field of machine learning and classification, and, more particularly, to greedy support vector machine classification for feature selection applied to the nodule detection problem.

2. Description of the Related Art

The analysis of computer tomography (“CT”) images in the detection of anatomically potential pathological structures (i.e., candidates), such as lung nodules and colon polyps, is a demanding and repetitive task. It requires a doctor to visually inspect CT images, likely resulting in human oversight errors. The oversight of nodules and polyps results in cancers potentially being undetected.

Computer-aided diagnosis (“CAD”) can be used to assist doctors in the detection and characterization of nodules in lung CT images. A primary goal of CAD systems is to classify candidates as nodules or non-nodules. As used herein, the term “candidates” refers to elements (i.e., structures) of interest in the image.

A classifier is used to classify (i.e., separate) objects into two or more classes. An example of a classifier is as follows. Assume we have a set, A, of objects comprising two groups (i.e., classes) of the objects that we will call A+ and A−. As used herein, the term “object” refers to one or more elements in a population. The classifier, A, is a function, F, that takes every element in A and returns a label “+” or “−”, depending on what group the element is. That is, the classifier may be a FUNCTION F(A)→{−1, 1}, where −1 is a numerical value representing A− and +1 is a numerical value representing A+. The classifiers A+ and A− may represent two separate populations. For example, A+ may represent structures in the lung (e.g., vessels, bronchi) and A− may represent nodules. Once the function, F, is trained from training data (i.e., data with known classifications), classifications of new and unseen data can be predicted using the function, F. For example, a classifier can be trained in 10,000 known objects for which we have readings from doctors. This is commonly referred to as a “ground truth.” Based on the training from the ground truth, the classifier can be used to automatically diagnose new and unseen cases.

An important component to classification is the determination of features used to train the classifier. As used herein, the term “feature” refers to one or more attributes that describe an object belonging to a particular class. For example, a nodule can be described by a vector containing a number of attributes, such as size, diameter, sphericity, etc. A small number of features is desired because it is often the case that the complexity of a classification method depends on the number of features. This often involves time-consuming, computationally expensive computations and requires large amounts of storage space on disk for each extracted or selected feature. It is also a very well known fact that a large number of features may lead to overfitting on the training set, which then leads to a poor generalization performance in new and unseen data.

A current approach to reduce the number of features used to train the classifier involves using principal component analysis (“PCA”). Principal component analysis involves a mathematical procedure that transforms (i.e., maps) a number of possibly correlated variables into a smaller number of uncorrelated variables called principal components. The first principal component accounts for as much of the variability in the data as possible, and each succeeding component accounts for as much of the remaining variability as possible.

A problem with PCA and other feature extraction methods is that it becomes unpractical when datasets are large. For example, mapping a large number of features to a smaller number of principal components does not eliminate the need for computationally expensive and time-consuming calculations, not only when the classifier is being trained but also when the classifier is being using to predict. Another problem with PCA is that it is unclear how to apply PCA to datasets with significantly unbalanced classes. This is typically the case in nodule detection where the number of false candidates can be very large (e.g., in the thousands) while the number of true positives is usually small (e.g., in the hundreds).

### SUMMARY OF THE INVENTION

In one exemplary aspect of the present invention, a method of selecting at least one feature from a feature space in a lung computer tomography image is provided. The at least one feature used to train a final classifier for determining whether a candidate is a nodule. The method comprises training a number of classifiers; wherein each of the number of classifiers is trained with a current feature set plus an additional feature not included in the current feature set; tracking the number of classifiers to determine a performance of each of the number of classifiers; and creating a new feature set by updating the current feature set to include the feature used to train the best performing classifier, if the performance of the best performing classifier exceeds a minimum performance threshold; wherein the performance of the each of the number of classifiers is based on whether the each of the number of classifiers accurately determines whether a candidate is a nodule.

In a second exemplary aspect of the present invention, a method of selecting at least one feature from a feature space in a lung computer tomography image is provided. The at least one feature used to train a final classifier for determining whether a candidate is a nodule. The method comprises initializing a current feature set as an empty feature set; training a number of classifiers; wherein each of the number of classifiers is trained with the current feature set plus an additional feature not included in the current feature set; tracking the number of classifiers to determine a performance of each of the number of classifiers; creating a new feature set by updating the current feature set to include the feature used to train the best performing classifier, if the performance of the best performing classifier exceeds a minimum performance threshold; wherein the performance of the each of the number of classifiers is based on whether the each of the number of classifiers accurately determines whether a candidate is a nodule; and repeating the steps of training, tracking and creating, using the new feature set as the current feature set, until the performance of the best performing classifier does not exceed the minimum performance threshold.

In a third exemplary aspect of the present invention, a machine-readable medium having instructions stored thereon for execution by a processor to perform method of selecting at least one feature from a feature space in a lung computer tomography image is provided. The at least one feature used to train a final classifier for determining whether a candidate is a nodule. The method comprises training a number of classifiers; wherein each of the number of classifiers is trained with a current feature set plus an additional feature not included in the current feature set; tracking the number of classifiers to determine a performance of each of the number of classifiers; and creating a new feature set by updating the current feature set to include the feature used to train the best performing classifier, if the performance of the best performing classifier exceeds a minimum performance threshold; wherein the performance of the each of the number of classifiers is based on whether the each of the number of classifiers accurately determines whether a candidate is a nodule.

In a fourth exemplary aspect of the present invention, a machine-readable medium having instructions stored thereon for execution by a processor to perform method of selecting at least one feature from a feature space in a lung computer tomography image is provided. The at least one feature used to train a final classifier for determining whether a candidate is a nodule. The method comprises initializing a current feature set as an empty feature set; training a number of classifiers; wherein each of the number of classifiers is trained with the current feature set plus an additional feature not included in the current feature set; tracking the number of classifiers to determine a performance of each of the number of classifiers; creating a new feature set by updating the current feature set to include the feature used to train the best performing classifier, if the performance of the best performing classifier exceeds a minimum performance threshold; wherein the performance of the each of the number of classifiers is based on whether the each of the number of classifiers accurately determines whether a candidate is a nodule; and repeating the steps of training, tracking and creating, using the new feature set as the current feature set, until the performance of the best performing classifier does not exceed the minimum performance threshold.

### BRIEF DESCRIPTION OF THE DRAWINGS

The invention may be understood by reference to the following description taken in conjunction with the accompanying drawings, in which like reference numerals identify like elements, and in which:

FIG. 1 depicts a flow diagram of an exemplary greedy method 100 of selecting features to be used in conjunction with a classifier, in accordance with one embodiment of the present invention;

FIG. 2 depicts an exemplary diagram illustrating a fundamental classification problem that leads to minimizing a piecewise quadratic strongly convex function.

### DETAILED DESCRIPTION OF PREFERRED EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It is to be understood that the systems and methods described herein may be implemented in various forms of hardware, software, firmware, special purpose processors, or a combination thereof. In particular, at least a portion of the present invention is preferably implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces. It is to be further understood that, because some of the constituent system components and process steps depicted in the accompanying Figures are preferably implemented in software, the connections between system modules (or the logic flow of method steps) may differ depending upon the manner in which the present invention is programmed. Given the teachings herein, one of ordinary skill in the related art will be able to contemplate these and similar implementations of the present invention.

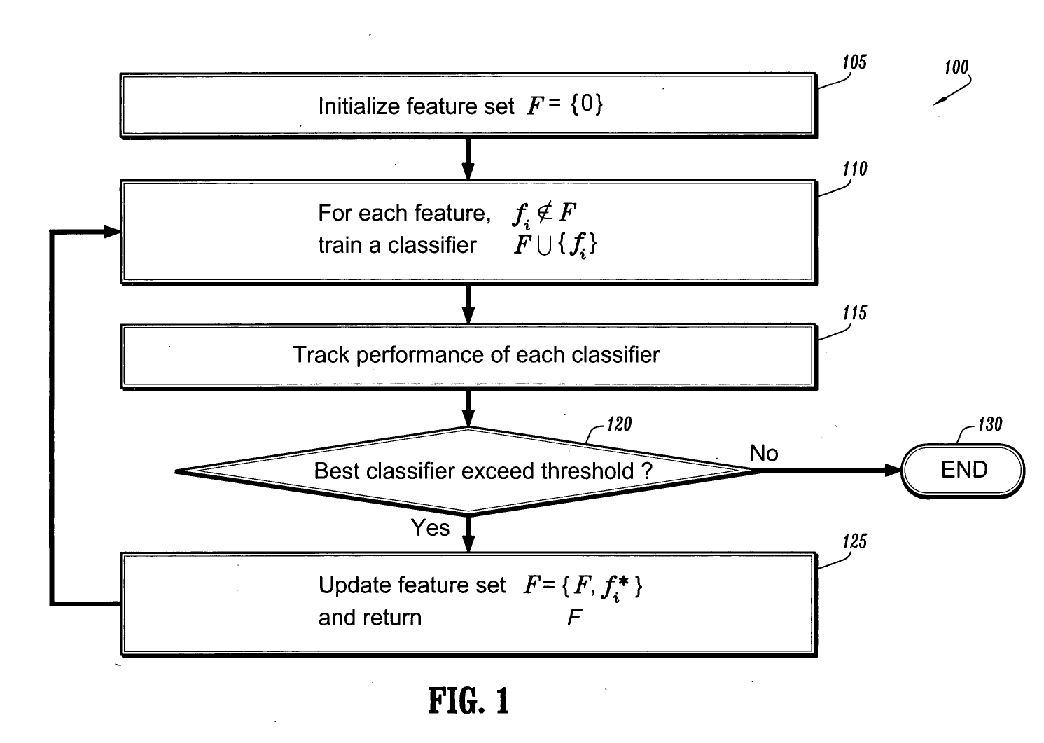

Referring now to FIG. 1, a flow diagram of an exemplary greedy method 100 of selecting features to be used in conjunction with a classifier, in accordance with one embodiment of the present invention. The exemplary greedy method depends on only a small subset of features in the feature space (i.e., all the features on the image) while improving or maintaining classification performance.

The method 100 is initialized (at 105) with an empty feature set, F. That is, no features have been selected. It is assumed here that we have i features in the feature space. We reference the i features using the notation fᵢ. For each feature fᵢ not in F, a classifier is trained (at 110) using features already chosen in F added with fᵢ (i.e., F union fi). Thus, assuming there are y features fᵢ not in F, the result of step 110 is y classifiers. The y classifiers are tracked (at 115) for their performance. Performance may be based on whether the classifier accurately detects and classifies candidates as nodules and non-nodules.

It is determined (at 120) whether the classifier with the best performance surpasses a minimum threshold improvement over the classifier simply using F (i.e., without the added fᵢ). This minimum threshold may be predetermined using any of a variety of factors as contemplated by those skilled in the art.

If the threshold improvement is met, then the fᵢ with the best associated classifier is added (at 125) to F, the newly updated feature set F is returned, and the method 100 repeats steps 110 to 120. If the threshold improvement is not met, then the method 100 terminates (at 130).

An exemplary implementation of method 100 is as follows. Assume there are three features A, B and C in the features space. An empty set, F, is initialized (at 105). Three classifiers are trained (at 110), each using one of the three features: C_{A}, C_{B} and C_{C}. Because the feature set was previously empty, each classifier is trained only with a single feature. We will assume that C_{A} refers to a classifier trained by feature A, C_{B} refers to a classifier trained by feature B, and C_{C} refers to a classifier trained in feature C.

We will further assume that after tracking (at 115) the classifiers over a plurality of test cases, it is determined that C_{A} provides a 98% improvement in performance over a classifier trained with zero features, C_{B} provides 95% improvement, and C_{C} provides a 72% improvement. Because C_{A} provides the best improvement, it is determined (at 120) whether the improvement of classifier C_{A} over the current classifier trained with zero features exceeds a predetermined threshold improvement. We will assume the threshold improvement is 90%. Because 98% improvement exceeds the 90% threshold, then feature A is added (at 125) to feature set F.

The method 100 begins again at step 110. Because feature A is already in set F, only two classifiers will now be trained (at 110), C_{B} and C_{C}. Once again, we will assume that C_{B} refers to a classifier trained by feature B added to feature set F (i.e., currently only element A), and C_{C} refers to a classifier trained in feature C added to feature set F.

We will further assume that after tracking (at 115) the classifiers over a predetermined period of time, it is determined that C_{B} provides 85% improvement, and C_{C} provides a 65% improvement. Because C_{B} provides the best improvement, it is determined (at 120) whether the improvement of classifier C_{B} over the current classifier trained with feature A exceeds a predetermined threshold improvement. Because the improvement of classifier over the current classifier does not exceed 90%, the method terminates (at 130).

The incremental greedy approach described in greater detail above and illustrated in FIG. 1 results in a final classifier that performs optimally and depends on only a few features. As previously stated, a small number of features is desired because it is often the case that the complexity of a classification method depends on the number of features; a large number of features may lead to overfitting on the training set, which then leads to a poor generalization performance in new and unseen data. The greedy method illustrated in FIG. 1 is based on feature selection of a limited subset of features from the feature space. By providing low feature dependency, the feature selection approach of the incremental greedy method requires fewer computations as compared to a feature extraction approach, such as PCA.

It should be appreciated that any of a variety of classifiers may be used to implement the method 100 of FIG. 1, as contemplated by those skilled in the art. Classifiers include, but are not limited to, support vector machines, neural networks, kernel methods and regularized networks. An exemplary vector machine that can be used with the greedy approach described above is a Newton Lagrangian support vector machine.

A Newton Lagrangian support vector machine (“NVSM”) classifier is used to separate true positive candidates (i.e., nodules) from false candidates (i.e., non-nodules). A linear classifier achieves this by building a separating hyperplane in the features space. When a nonlinear classifier is used, the original data is mapped into a higher dimensional space where a linear separator is found that is nonlinear in the original input space.

A more detailed description of a NVSM classier will be provided.

Linear and Nonlinear Kernel Classification

We describe in this section the fundamental classification problems that lead to minimizing a piecewise quadratic strongly convex function. We consider the problem of n classifying m points in the n-dimensional real space Rⁿ, represented by the m×n matrix A, according to membership of each point Aᵢ in the classes +1 or −1 as specified by a given m×m diagonal matrix D with ones or minus ones along its diagonal. For this problem, the standard support vector machine with a linear kernel AA′ is given by the following quadratic program for some v>0:

$${min}_{( w , γ , y ) ∈ {R}^{n + 1 + m}} {ve}^{′} y + \frac{1}{2} {w}^{′} w \\ s . t . D ( Aw - e γ ) + y \geq e \\ y \geq 0. \qquad ( 1 )$$

As depicted in FIG. 1, w is the normal to the bounding planes:
x′w−γ=+1
x′w−γ=−1, (2)
and γ determines their location relative to the origin. The first plane above bounds the class +1 points and the second plane bounds the class −1 points when the two classes are strictly linearly separable, that is, when the slack variable y=0. The linear separating surface is the plane
x′w=γ, (3)
midway between the bounding planes (2). If the classes are linearly inseparable, then the two planes bound the two classes with a “soft margin” determined by a nonnegative slack variable y, that is:
x′w−γ+yᵢ≧+1, for x′=Aᵢ and Dᵢᵢ=+1,
x′w−γ−yᵢ≦+1, for x′=Aᵢ and Dᵢᵢ=−1. (4)
The 1-norm of the slack variable y is minimized with weight v in (1). The quadratic term in (1), which is twice the reciprocal of the square of the 2-norm distance

$$\frac{2}{‖ w ‖}$$

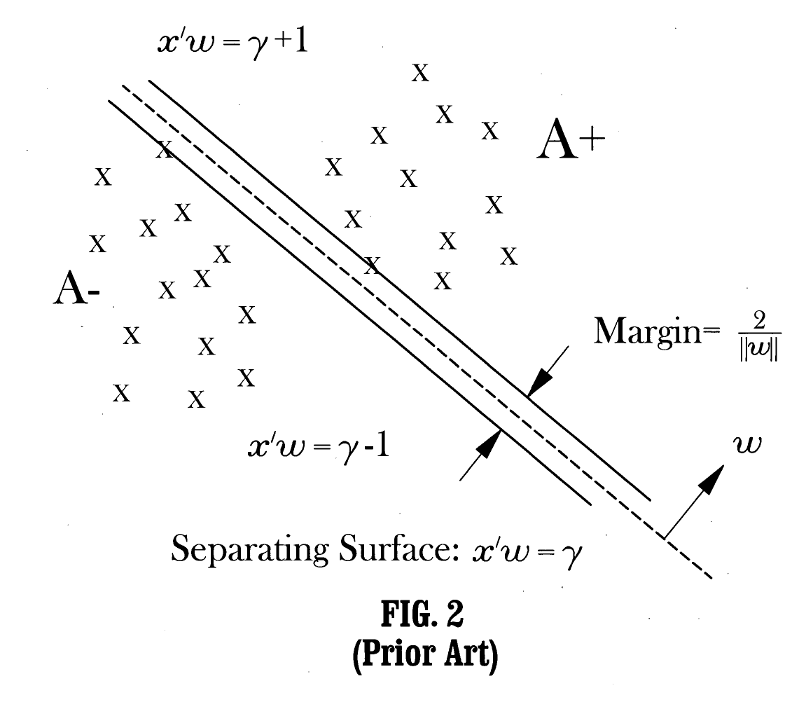

between the two bounding planes of (2) in the n-dimensional space of wεRⁿ for a fixed γ, maximizes that distance, often called the “margin.” FIG. 2 depicts the points 2 represented by A, the bounding planes (3) with margin

$$\frac{2}{‖ w ‖} ,$$

and the separating plane (3) which separates A+, the points represented by rows of A with Dᵢᵢ=+1, from A−, the points represented by rows of A with Dᵢᵢ=−1.

In many essentially equivalent formulations of the classification problem, the square of 2-norm of the slack variable y is minimized with weight

$$\frac{v}{2}$$

instead of the 1-norm of y as in (2). In addition, the distance between the planes (2) is measured in the (n+1)-dimensional space of (w, γ)εRⁿ⁺¹, that is

$$\frac{2}{‖ ( w , γ ) ‖} .$$

Measuring the margin in this (n+1)-dimensional space instead of Rⁿ induces strong convexity. Thus using twice the reciprocal squared of the margin instead, yields our modified SVM problem as follows:

$${min}_{( w , γ , y ) ∈ {R}^{n + 1 + m}} \frac{v}{2} {y}^{′} y + \frac{1}{2} ( {w}^{′} w + {γ}^{2} ) \\ s . t . D ( Aw - e γ ) + y \geq e \\ y \geq 0. \qquad ( 5 )$$

It has been shown computationally that this reformulation (5) of the conventional support vector machine formulation (1) often yields similar results to (1). The dual of this problem is:

$${min}_{0 \leq u ∈ {R}^{m}} \frac{1}{2} {u}^{′} ( \frac{I}{v} + D ( {AA}^{′} + {ee}^{′} ) D ) u - {e}^{′ } u . \qquad ( 6 )$$

The variables (w, γ) of the primal problem which determine the separating surface (3) are recovered directly from the solution of the dual (6) above by the relations:

$$w = {A}^{′} Du , y = \frac{u}{v} , γ = - {e}^{′} Du . \qquad ( 7 )$$

We immediately note that the matrix appearing in the dual objective function is positive definite. We simplify the formulation of the dual problem (6) by defining two matrices as follows:

$$H = D [ \begin{matrix}A & - e\end{matrix} ] , Q = \frac{I}{v} + {HH}^{′} . \qquad ( 8 )$$

With these definitions, the dual problem (6) becomes:

$${min}_{0 \leq u ∈ {R}^{m}} f ( u ) := \frac{1}{2} {u}^{′} Qu - {e}^{′} u . \qquad ( 9 )$$

For AεR^{m×n} and BεR^{n×l}, the kernel K(A,B) maps R^{m×n}×R^{n×l} into R^{m×l}. A typical kernel is the Gaussian kernel ε−μ∥Aᵢ′−B_{*j}∥²,u,j=1, . . . , m,l=m, where ε is the base of natural logarithms, while a linear kernel is K(A,B)=AB. For a column vector x in Rⁿ, K(x′, A′) is a row vector in R^{m}, and the linear separating surface (3) is replaced by the nonlinear surface:
K(x′,A′)Du=γ, (10)
where u is the solution of the dual problem (6) with the linear kernel AA′ replaced by the nonlinear kernel product K(A,A′)K(A,A′)′, that is:

$${min}_{0 \leq u ∈ {R}^{m}} \frac{1}{2} {u}^{′} ( \frac{I}{v} + D ( K ( A , {A}^{′} ) {K ( A , {A}^{′} )}^{′} + {ee}^{′} ) Du ) - {e}^{′} u . \qquad ( 11 )$$

This leads to a redefinition of the matrix Q of (9) as follows

$$H = D [ K ( A , {A}^{′} ) - e ] , Q = \frac{I}{v} + {HH}^{′} . \qquad ( 12 )$$

It should be noted that the nonlinear separating surface (10) degenerates to the linear one (3) if we let K(A,A′)=AA′ and make use of (7).

We describe now a general framework for generating a fast and effective method for solving the quadratic program (9) by solving a system of linear equations a finite number of times.

Implicit Lagrangian Formulation

The implicit Lagrangian formulation comprises replacing the nornnegativity constrained quadratic minimization problem (9) by the equivalent unconstrained piecewise quadratic minimization of the implicit Lagrangian L(u):

$$\begin{matrix}{min}_{u ∈ {R}^{m}} = {min}_{u ∈ {R}^{m}} \frac{1}{2} {u}^{′} Qu - {e}^{′} u + \\ \frac{1}{2 α} ( {‖ {( - α u + Qu - e )}_{+} ‖}^{2} - {‖ Qu - e ‖}^{2} ) ,\end{matrix} \qquad ( 13 )$$

where α is a sufficiently large but finite positive parameter, and the plus function (•)₊, where (x₊)ᵢ=max {0,xᵢ},i=1, . . . , n, replaces negative components of a vector by zeros. Reformulation of the constrained problem (9) as an unconstrained problem (13) is based on ideas of converting the optimality conditions of (9) to an unconstrained minimization problem as follows. Because the Lagrange multipliers of the constraints u≧0 of (9) turn out to be components of the gradient Qu−e of the objective function, these components of the gradient can be used as Lagrange multipliers in an Augmented Lagrangian formulation of (9) which leads precisely to the unconstrained formulation (13). Our finite Newton method comprises applying Newton's method to this unconstrained minimization problem and showing that it terminates in a finite number of steps at the global minimum. The gradient of L(u) is:

$$\begin{matrix}∇ L ( u ) = ( Qu - e ) + \frac{1}{α} ( Q - α I ) {( ( Q - α I ) u - e )}_{+} - \frac{1}{α} Q ( Qu - e ) \\ = \frac{( α I - Q )}{α} ( ( Qu - e ) - {( ( Q - α I ) u - e )}_{+} ) .\end{matrix} \qquad ( 14 )$$

To apply the Newton method we need the m×m Hessian matrix of second partial derivatives of L(u), which does not exist in the ordinary sense because its gradient, ∇L(u), is not differentiable. However, a generalized Hessian of L(u) in the sense of exists and is defined as the following m×m matrix:

$${\partial }^{2 L ( u ) = \frac{( α I - Q )}{α}} ( Q + diag ( Q - α I ) u - e ) * ( α I - Q ) ) , \qquad ( 15 )$$

where, diag(•)_{*} denotes a diagonal matrix and (•)_{*} denotes the step function. Our basic Newton step comprises solving the system of m linear equations:
∇L(uⁱ)+∂²L(uⁱ)(uⁱ⁺¹−uⁱ)=0, (16)
for the unknown m×1 vector uⁱ⁺¹ given a current iterate uⁱ.

Finite Newton Classification Method

The Newton method for solving the piecewise quadratic minimization problem (13) for an arbitrary positive definite Q is as follows. Let h(u) be defined as follows:

$$h ( u ) := ( Qu - e ) - {( ( Q - α I ) u - e )}_{+} = {( \frac{α I - Q}{α} )}^{- 1} ∇ L ( u ) \qquad ( 17 )$$

Let ∂h(u) be defined as follows:

$$\partial h ( u ) := Q + E ( u ) ( α I - Q ) = P ( u ) = {( \frac{α I - Q}{α} )}^{- 1} {\partial }^{2} L ( u ) . \qquad ( 18 )$$

Start with any u⁰εR^{m}. For i=0,1 . . . :
(i) Stop if h(uⁱ−∂h(uⁱ)⁻¹h(uⁱ))=0.

$$( ii ) {u}^{i + 1} = {u}^{i} - {λ}_{i} \partial {h ( {u}^{i} )}^{- 1} h ( {u}^{i} ) = {u}^{i} + {λ}_{i} {d}^{i} , \\ where {λ}_{i} = max \{ 1 , \frac{1}{2} , \frac{1}{4} , … \} is the$$

Armijo stepsize such that:
L(uⁱ)−L(uⁱ+λᵢdⁱ)≧−δλᵢΔL(uⁱ)′dⁱ, (19)
for some

$$δ ∈ ( 0 , \frac{1}{2} ) ,$$

and dⁱ is the Newton direction:
dⁱ=−∂h(uⁱ)⁻¹h(uⁱ), (20)
obtained by solving:
h(uⁱ)+∂h(uⁱ)(uⁱ⁺¹−uⁱ)=0, (21)
which is a simplified Newton iteration (16).

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method of selecting at least one feature from a feature space in a lung computer tomography image, the at least one feature used to train a final classifier for determining whether a candidate is a nodule, comprising:
training a number of classifiers;
wherein each of the number of classifiers is trained with a current feature set plus an additional feature not included in the current feature set;
tracking the number of classifiers to determine a performance of each of the number of classifiers; and
creating a new feature set by updating the current feature set to include the feature used to train the best performing classifier, if the performance of the best performing classifier exceeds a minimum performance threshold;
wherein the performance of the each of the number of classifiers is based on whether the each of the number of classifiers accurately determines whether a candidate is a nodule.

2. The method of claim 1, further comprising initializing the feature set to an empty feature set.

3. The method of claim 1, further comprising repeating the steps of training, tracking and creating until the performance of the best performing classifier does not exceed the minimum performance threshold.

4. The method of claim 3, further comprising using the new feature set as the current feature set in the step of repeating.

5. The method of claim 1, wherein the number of classifiers comprises at least one of support vector machine classifiers, neural network classifiers, kernel method classifiers and regularized network classifiers.

6. The method of claim 1, wherein the number of classifiers comprises Newton Lagrangian support vector machine (“NVSM”) classifiers.

7. The method of claim 1, wherein training a number of classifiers comprises training the number of classifiers using a ground truth.

8. The method of claim 1, wherein the performance of each of the number of classifiers is determined over a plurality of test cases.

9. The method of claim 1, wherein a minimum performing threshold comprises a predetermined minimum performing threshold.

10. A method of selecting at least one feature from a feature space in a lung computer tomography image, the at least one feature used to train a final classifier for determining whether a candidate is a nodule, comprising:
initializing a current feature set as an empty feature set;
training a number of classifiers;
wherein each of the number of classifiers is trained with the current feature set plus an additional feature not included in the current feature set;
tracking the number of classifiers to determine a performance of each of the number of classifiers;
creating a new feature set by updating the current feature set to include the feature used to train the best performing classifier, if the performance of the best performing classifier exceeds a minimum performance threshold;
wherein the performance of the each of the number of classifiers is based on whether the each of the number of classifiers accurately determines whether a candidate is a nodule; and
repeating the steps of training, tracking and creating, using the new feature set as the current feature set, until the performance of the best performing classifier does not exceed the minimum performance threshold.

11. A machine-readable medium having instructions stored thereon for execution by a processor to perform method of selecting at least one feature from a feature space in a lung computer tomography image, the at least one feature used to train a final classifier for determining whether a candidate is a nodule, the method comprising:
training a number of classifiers;
wherein each of the number of classifiers is trained with a current feature set plus an additional feature not included in the current feature set;
tracking the number of classifiers to determine a performance of each of the number of classifiers; and
creating a new feature set by updating the current feature set to include the feature used to train the best performing classifier, if the performance of the best performing classifier exceeds a minimum performance threshold;
wherein the performance of the each of the number of classifiers is based on whether the each of the number of classifiers accurately determines whether a candidate is a nodule.

12. A machine-readable medium having instructions stored thereon for execution by a processor to perform method of selecting at least one feature from a feature space in a lung computer tomography image, the at least one feature used to train a final classifier for determining whether a candidate is a nodule, the method comprising:
initializing a current feature set as an empty feature set;
training a number of classifiers;
wherein each of the number of classifiers is trained with the current feature set plus an additional feature not included in the current feature set;
tracking the number of classifiers to determine a performance of each of the number of classifiers;
creating a new feature set by updating the current feature set to include the feature used to train the best performing classifier, if the performance of the best performing classifier exceeds a minimum performance threshold;
wherein the performance of the each of the number of classifiers is based on whether the each of the number of classifiers accurately determines whether a candidate is a nodule; and
repeating the steps of training, tracking and creating, using the new feature set as the current feature set, until the performance of the best performing classifier does not exceed the minimum performance threshold.
